(19) United States
(12) Patent Application Publication
(10) Pub. No.: US 2021/0371046 A1
(43) Pub. Date: Dec. 2, 2021

(54) PEDAL ASSEMBLY FOR A GEAR DRIVEN CYCLE

(71) Applicant: Albert Aguilar, Zapopan (MX)

(72) Inventor: Albert Aguilar, Zapopan (MX)

(21) Appl. No.: 17/197,819

(22) Filed: Mar. 10, 2021

Related U.S. Application Data
(60) Provisional application No. 62/987,644, filed on Mar. 10, 2020.

(51) Int. Cl. B62M 3/00; B62M 3/16; B62M 9/138; B62M 1/36

(52) U.S. Cl. CPC B62M 3/003; B62M 1/36; B62M 9/138; B62M 3/16

(57) ABSTRACT

Disclosed herein is a transmission assembly for a wheeled vehicle. The assembly has a gear box superposed over an existing prior art bicycle. Based on the gear ratios of the gear box, the power input of a rider is increased in the same amount.

### CROSS-REFERENCE TO RELATED APPLICATIONS

The present invention claims priority to U.S. Provisional Patent Application No. 62/987,644 filed Mar. 10, 2020, the contents of which are incorporated in their entirety herein by reference and made a part hereof.

### FEDERALLY SPONSORED RESEARCH OR DEVELOPMENT

N/A

### FIELD OF THE INVENTION

A transmission for a wheeled vehicle driven by a gear and more particularly to a bicycle having a foot pedal driven by a foot of a user and connected to a transmission for converting rotational motion of the pedal into linear motion of the bicycle.

### DESCRIPTION OF THE PRIOR ART

Unicycles, bicycles, tricycles, and multi-wheeled vehicles have been around for many years. Bicycles typically have a pedal mounted in a crank case for rotational motion that when rotated by a foot or feet of a user cause a large sprocket to rotate about an axis. The large sprocket is connected by a chain to a rear sprocket or a cassette of sprockets of various sizes that is connected to an axle of a rear wheel. Rotation of the pedal causes the large sprocket to rotate, which causes the chain to rotate, which in turn causes the rear sprocket to rotate, which causes the rear wheel to rotate. The large sprocket and rear sprocket or sprockets can have teeth that engage the chain. A ratio of the number of teeth in the large sprocket compared to the rear sprocket determines how many times the rear wheel rotates per rotation of the large sprocket. This assembly or system of parts is known as a transmission. FIG. 2 shows a prior art bicycle transmission and FIG. 4 shows a bicycle transmission of the present invention that is superposed on the prior art transmission. Based on the gear ratio of the transmission of the present invention, the power output of the bike is increased in this amount. If the transmission has a 2 to 1 gear ratio, the power output of the bicycle will be doubled with the same power input by a rider of the bicycle.

### SUMMARY OF THE INVENTION

Disclosed herein is a transmission assembly for a wheeled vehicle. The assembly has a gear box having a pair of opposed walls defining a chamber therebetween. A driver sprocket is positioned in the chamber and is fixedly mounted to at least one side wall of the pair of side walls. The driver sprocket has a centrally disposed through hole. A first axle is positioned in the chamber extending between the opposed walls and orthogonal thereto. The first axle has a member for attaching to a frame to mount the gear box for rotational movement about the first axle. A first driven gear is mounted on the first axle for rotation thereabout and is spaced from the driver sprocket. A chain tensioning mechanism positioned in the chamber and secured to at least one side wall of the pair of opposed side walls. A power input shaft has opposed ends, a first end is positioned in the through hole and a second end extends outward from the gear box and has a flange. The power input shaft is fixedly attached to the gear box. A chain is entrained about the driver sprocket, the first driven gear, and the chain tensioning mechanism to define a gear train. Wherein upon applying a force to the flange the gear box rotates about the first axle and the chain is driven through the gear train and rotates the first driven gear about the first axle.

Also disclosed herein is a transmission assembly for a bicycle. The transmission has a chain ring for mounting to a frame of a bicycle. The chain ring has a circular wall with a plurality of teeth disposed on a peripheral edge circumferentially spaced from one another. The chain ring has a first centrally disposed through hole. A gear box has a pair of opposed walls defining a chamber therebetween. A driver sprocket is positioned in the chamber and is fixedly mounted to at least one side wall of the pair of side walls, the driver sprocket has a second centrally disposed through hole. A first axle is positioned in the chamber and extends between the opposed walls and orthogonal thereto. A. first driven gear is mounted on the first axle for rotation thereabout and is spaced from the driver sprocket. A second axle has a first end and an opposed second end, the first end is fixedly attached to the first driven gear and the second end is disposed in the first through hole to lock the first driven gear and the chain ring for co-rotational motion about an axis through the first axle. A chain tensioning mechanism is positioned in the chamber and is secured to at least one side wall of the pair of opposed side walls. A power input shaft has opposed ends, a first end is positioned in the second through hole and a second end extends outward from the gear box and has a flange. The power input shaft is fixedly attached to the gear box. A chain is entrained about the driver sprocket, the first driven gear, and the chain tensioning mechanism to define a gear train. Wherein upon applying a force to the flange the gear box rotates about the axis and the chain is driven through the gear train and rotates the first driven gear and the chain ring about the axis.

Also disclosed herein is a bicycle. The bicycle has frame having a first end and an opposed second end. The first end has a first bracket for mounting a first wheel and the second end has a second bracket for mounting a second wheel. The frame also has a bottom bracket positioned intermediate of the first end and the second end. The bottom bracket has a sleeve with a centrally disposed axis and openings at opposed ends. A chain ring is mounted to the bottom bracket for rotation about the axis. The chain ring has a circular wall with a plurality of teeth disposed on a peripheral edge circumferentially spaced from one another. The chain ring has a first centrally disposed through hole. A gear box has a pair of opposed walls defining a chamber therebetween. A driver sprocket is positioned in the chamber and is fixedly mounted to at least one side wall of the pair of side walls. The driver sprocket has a second centrally disposed through hole. A first axle is positioned in the chamber extending between the opposed walls and orthogonal thereto. A first driven gear is mounted on the first axle for rotation about the axis and is spaced from the driver sprocket. A second axle having a first end and an opposed second end, the first end is fixedly attached to the first driven gear and the second end is disposed in the first through hole to lock the first driven gear and the chain ring for co-rotational motion about the axis. A chain tensioning mechanism is positioned in the chamber and secured to at least one side wall of the pair of opposed side walls. A power input shaft has opposed ends, a first end is positioned in the second through hole and a second end extends outward from the gear box and has a flange. The power input shaft is fixedly attached to the gear box. A first chain is entrained about the driver sprocket, the first driven gear, and the chain tensioning mechanism to define a gear train. Wherein upon applying a force to the flange the gear box rotates about the axis and the first chain is driven through the gear train and rotates the first driven gear and the chain ring about the axis.

Other features and advantages of the invention will be apparent from the following specification taken in conjunction with the following Figures.

### BRIEF DESCRIPTION OF THE DRAWINGS

To understand the present invention, it will now be described by way of example, with reference to the accompanying drawings and attachments in which:

FIG. 1 is a side elevation view of a prior art bicycle.

FIG. 2 is a schematic representation of a prior art transmission for a bicycle.

FIG. 3 is a side elevational view of a bicycle of the present invention.

FIG. 4 is a schematic representation of a transmission for a wheeled vehicle of the present invention.

FIG. 5 is a top plan view of a gear box with a side wall removed to show an inner chamber of the gear box.

FIG. 6 is a top plan view of the gear box.

FIG. 7 is a perspective view of a driven gear.

FIG. 8 is a top plan view of a portion of a wall of the gear box for receiving the driven gear.

FIG. 9 is a side elevation view of a tensioning mechanism.

FIG. 10 is a side elevation view of a driven wheel of a tensioning mechanism.

FIG. 11 is a spreadsheet showing power calculations for a prior art bicycle.

FIG. 12 is a spreadsheet showing power calculations for the bicycle of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

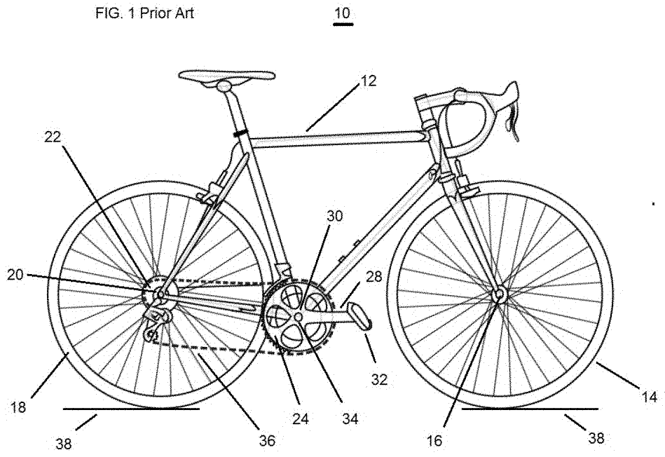

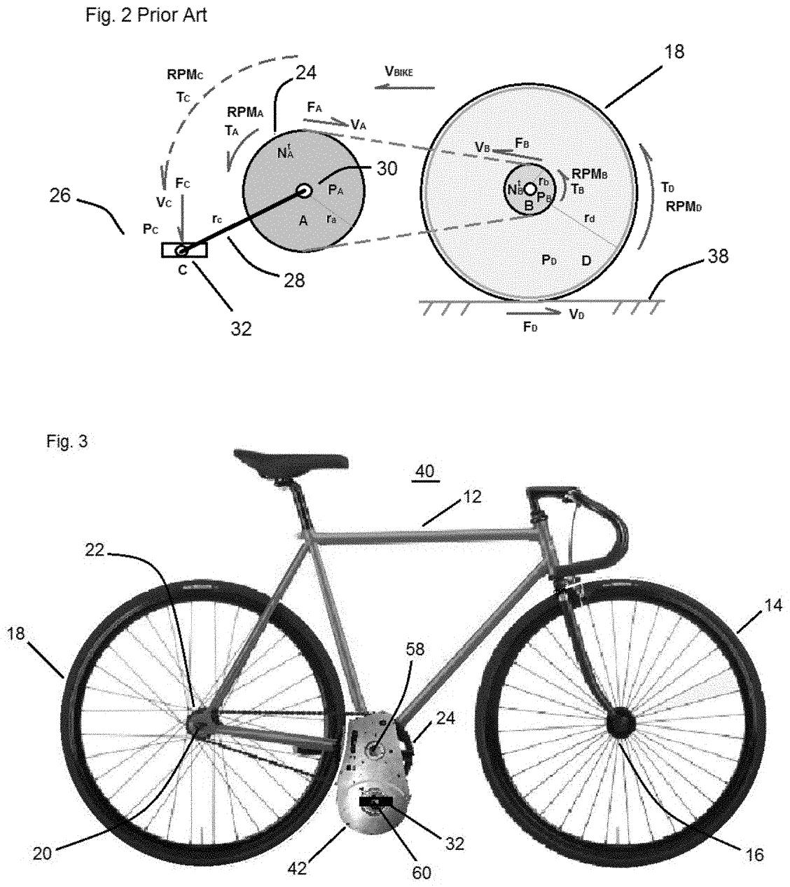

FIGS. 1 and 2 show a prior art bicycle 10 having a frame 12, a front wheel 14, mounted on a first or front bracket 16, a rear wheel 18 mounted on a second or rear bracket 20, a driven gear 22 for the rear wheel, a chain ring 24, a pedal assembly 26, a crank arm 28, a crank spindle 30, a pedal 32, and a bottom bracket 34. The bottom bracket 34 has a sleeve that extends through the frame from a right side of the bike to a left side of the bike. The crank spindle 30 is disposed in the sleeve and has opposed ends extending outward from the sleeve. The chain ring 24 is fixedly attached to one end of the crank spindle. The pedal assembly 26 is attached to the chain ring for co-rotation about an axis extending through the crank spindle. A second pedal assembly 26, not shown, is disposed on the left side of the bike. A first chain 36 is disposed about the driven gear 22 and the chain ring 24. By applying a force to one or both pedals, the chain ring rotates in a clockwise manner causing the chain to move and drive the driven gear, which in turns causes the rear wheel 18 to rotate in a clockwise fashion to propel the bicycle in a forward direction along a ground 38 surface.

FIG. 3 shows a bicycle 40 of the present invention and like parts will be referred to with like numbers used to describe the prior art bike. It should be understood the gear box of the present invention will be described with respect to a bicycle it could also be used with any gear driven cycle in the market that uses a crank or pedal as an input for energy. This includes unicycles, bicycles, tricycles, and those vehicles having more than three wheels. It applies to all types of bicycles including road bikes, mountain bikes, recumbent bikes, and others well known to those having ordinary skill in the art.

A gear box 42 is mounted to the bicycle on the right-hand side of the bike and connected the chain ring 24 for co-rotation about the axis with the chain ring 24. The gear box 42 could also be connected on the left-hand side of the bike and connected to the crank spindle which in turn is connected to the chain ring. The gear box 42 has opposed side walls 43 defining a chamber 44 therebetween. A driver sprocket 45 is fixedly attached to one or both side walls with a fastener 48 and has a centrally disposed through hole 46 in registration with a hole extending through a side wall 43. A second driven gear 52 is rotatably mounted over an annular wall 50 upstanding from one sidewall to act as an axle. The annular wall or axle 50 has a centrally disposed through hole 51 that extends through the side wall 43. A second chain 56 is entrained about the driver sprocket 45 and the driven gear 52. The second chain 56 passes through a chain tensioning mechanism 54.

The gear box 42 is attached to the bicycle 40 using an axle 58 that has a first end positioned in the through hole 51 of the second driven gear 52 and is fixedly attached thereto. A second end extends outward of the side wall 43 and is fixedly attached to the chain ring 24 so that the gear box 42 and the chain ring 24 co-rotate about the axis during operation of the bicycle. A power input shaft 60 has opposed ends with a first end positioned in the through hole 46 of the driver sprocket 45 and a second end extends outward through the side wall 43 and terminates in a pedal 32.

The driver sprocket 45 has a first diameter and a first number of teeth. The drive sprocket will be selected from existing bicycle parts and will typically have from 30 teeth to 60 teeth. Based on the skill and fitness level of the cyclist with less fit riders using driver sprockets with fewer teeth than a more fit rider. Typically, the bicycle is fitted with a desired driver sprocket and a driven gear and this is not changed. Of course, it is possible to change the gear ratios if necessary. The driven gear has a second diameter and a second number of teeth less than those of the drive sprocket. The driven gear will be selected from rear sprockets having from 10 to 50 teeth. The ratio of the number of teeth of the drive sprocket and the driven sprocket determines the number of rotations the driven gear makes per rotation of the driver sprocket. If the driver sprocket has twice as many teeth as the driven gear than the driven gear rotates twice for every rotation of the driver sprocket which is known as a gear ratio.

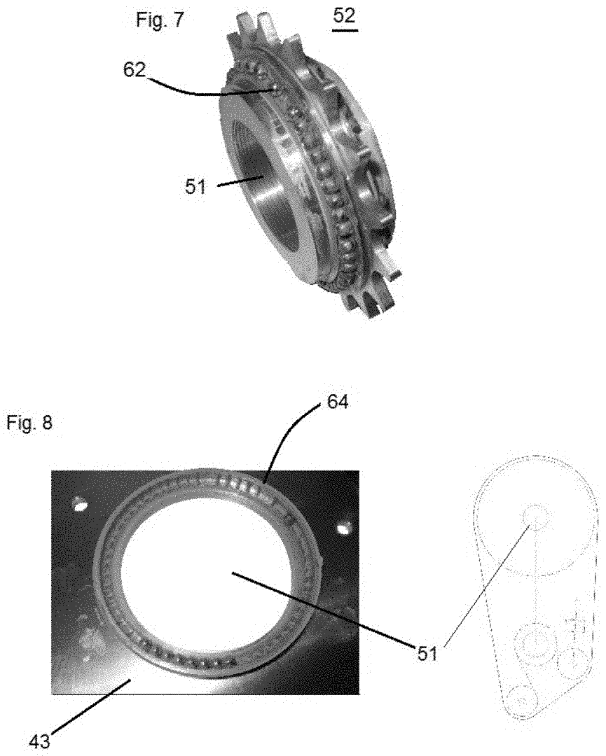

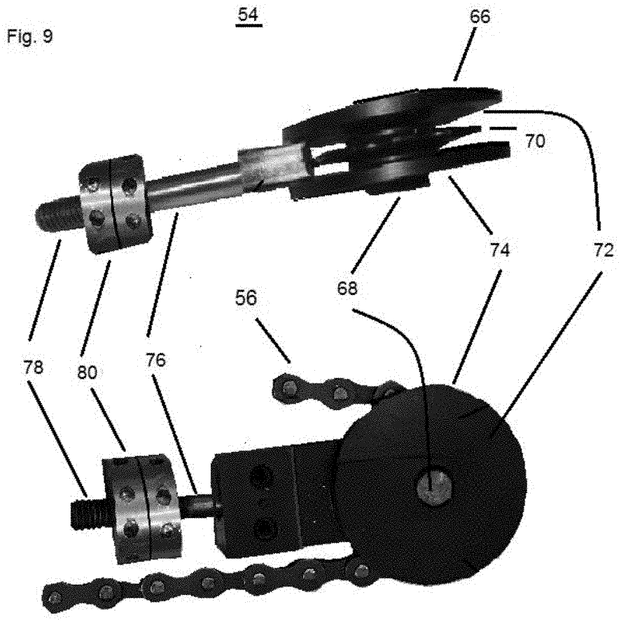

FIGS. 7 and 8 show the driven gear 52 has a plurality of ball bearing 62 disposed about its circumference. A bearing channel 64 is located on an inner surface of the side wall to retain the bearings in place when the driven gear is placed over the channel.

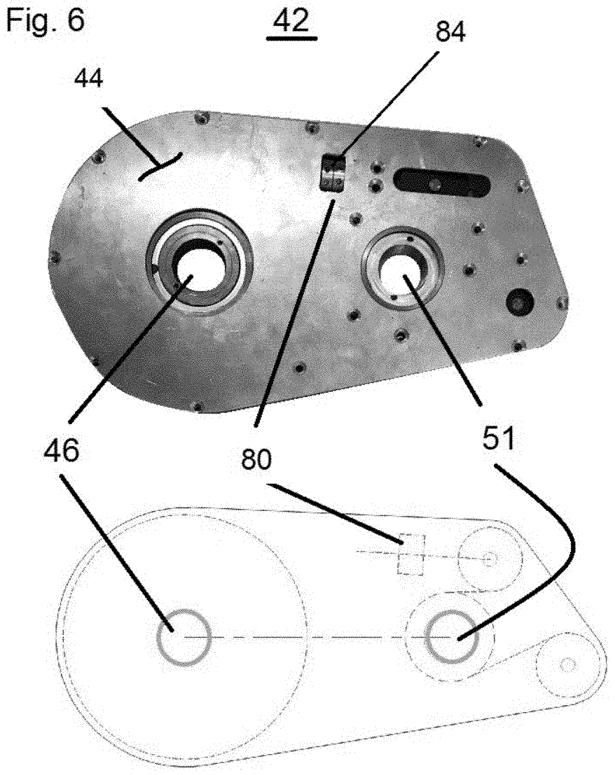

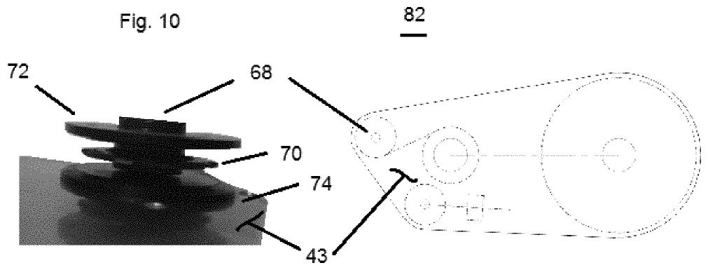

FIGS. 9 and 10 show parts of the chain tensioning mechanism 54. A first member 66 has an axle 68, a driven gear 70, a first annular flange 72, a second annular flange 74, a tensioning arm 76, threads 78, and a lock nut 80. A second member 82 is shown in FIG. 10 which is the same as that shown in FIG. 9 but it lacks the tensioning arm. The driven gear 70 is mounted on an axle that extends orthogonal to a side wall. The first annular flange 72 is disposed on a distal end of the axle 68 and the second annular flange 74 is disposed at a proximal end of the axle, and the driven gear is disposed therebetween. The first annular flange and the second annular flange preferably have a diameter greater than that of the driven gear 70. A portion of the lock nut 80 extends through a through hole 84 of the side wall (FIG. 6) for adjustment to compensate for slack in the chain.

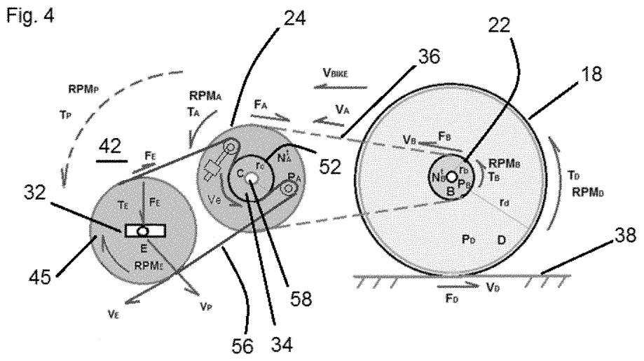

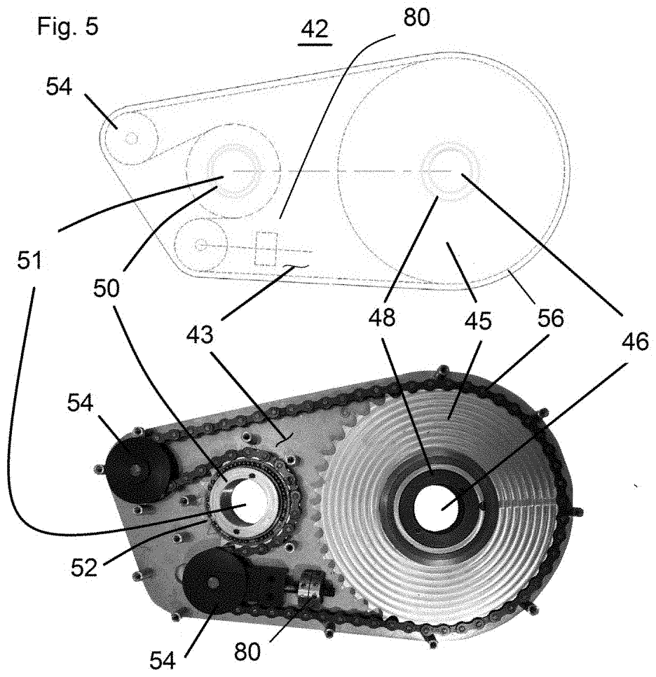

FIG. 4 shows how the gearbox 42 operates. When a downward force is applied to the pedal 32 the gear box rotates clockwise, the second chain 56 moves counterclockwise, the driven gear 52 moves clockwise, the chain ring 24 and the first chain 36 of the prior art bicycle move clockwise, and the driven gear 22 and the rear wheel 18 move clockwise to propel the bicycle forward. FIG. 2 shows the operation of a prior art bicycle. The gear box increases the speed of the prior art bicycle. In all high to low gearing we see a 244% increase in speed for the same gearing with a gear box gearing of 44/18. If the gearbox has a gearing of 53/11 your speed would now improve 500%. Thus, a rider would now do 2.44 or 5.00 times more distance travelled for the same energy or if the slowed down he can pedal slowly, using less energy and travel at his usual speed (but with less effort).

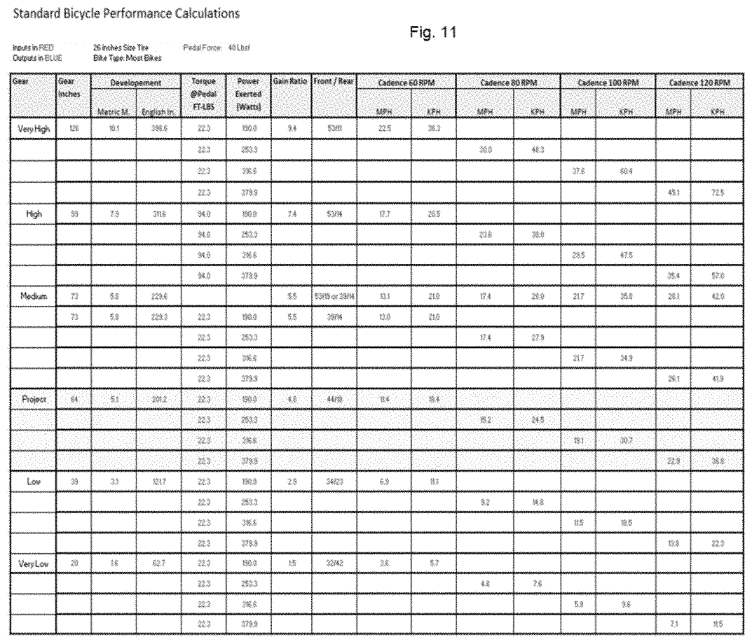

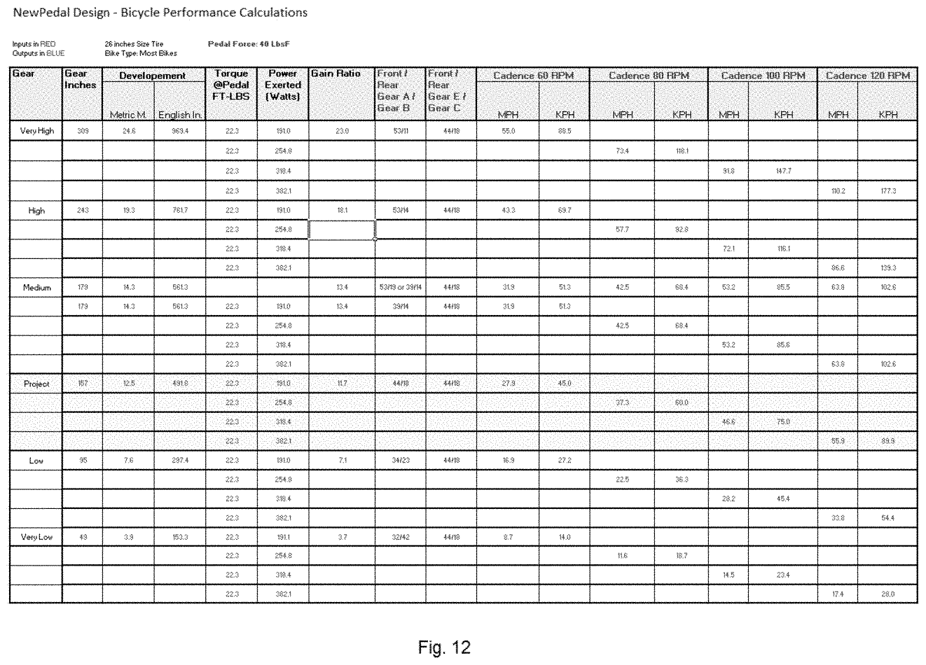

FIG. 11 shows performance calculations for prior art bicycles and FIG. 12 shows performance calculations for a bicycle of the present invention.

Many modifications and variations of the present invention are possible in light of the above teachings. It is, therefore, to be understood within the scope of the appended claims the invention may be protected otherwise than as specifically described.

I claim:

1. A transmission assembly for a wheeled vehicle comprising:
a gear box having a pair of opposed walls defining a chamber therebetween;
a driver sprocket positioned in the chamber and is fixedly mounted to at least one side wall of the pair of side walls, the driver sprocket has a centrally disposed through hole;
a first axle positioned in the chamber extending between the opposed walls and orthogonal thereto, the first axle has a member for attaching to a frame to mount the gear box for rotational movement about the first axle;
a first driven gear is mounted on the first axle for rotation thereabout and is spaced from the driver sprocket;
a chain tensioning mechanism positioned in the chamber and secured to at least one side wall of the pair of opposed side walls;
a power input shaft has opposed ends, a first end is positioned in the through hole and a second end extends outward from the gear box and has a flange, the power input shaft is fixedly attached to the gear box;
a chain is entrained about the driver sprocket, the first driven gear, and the chain tensioning mechanism to define a gear train; and,
wherein upon applying a force to the flange the gear box rotates about the first axle and the chain is driven through the gear train and rotates the first driven gear about the first axle.

2. The assembly of claim 1 wherein the driver sprocket has a first diameter and a first number of teeth disposed on a peripheral edge of the driver sprocket and circumferentially spaced from one another.

3. The assembly of claim 2 wherein the first driven gear has a second diameter and a second number of teeth disposed on a peripheral edge of the first driven gear and circumferentially spaced from one another, the second diameter is less than the first diameter and the second number of teeth is less than the first number of teeth.

4. The assembly of claim 1 wherein the tensioning mechanism comprises:
a second axle positioned in the chamber extending between the opposed walls and orthogonal thereto;
a second driven gear spaced from the first driven gear and is mounted on the second axle for rotation thereabout;
a third axle positioned in the chamber extending between the opposed walls and orthogonal thereto; and,
a third driven gear spaced from the second driven gear and is mounted on the third axle for rotation thereabout.

5. The assembly of claim 4 wherein the second driven gear has a third diameter and a third number of teeth on a peripheral edge and circumferentially spaced from one another.

6. The assembly of claim 5 wherein the second driven gear further comprises a first annular flange of a fourth diameter mounted on a distal end of the second axle, the fourth diameter is greater than the third diameter.

7. The assembly of claim 6 further comprising a second annular flange mounted on a proximal end of the second axle and the second driven gear is disposed between the first annular flange and the second annular flange.

8. The assembly of claim 1 further comprising a plurality of ball bearings for rotatably mounting the first driven gear.

9. A transmission assembly for a bicycle comprising:
a chain ring for mounting to a frame of a bicycle, the chain ring having a circular wall with a plurality of teeth disposed on a peripheral edge circumferentially spaced from one another, the chain ring has a first centrally disposed through hole;
a gear box having a pair of opposed walls defining a chamber therebetween;
a driver sprocket positioned in the chamber and is fixedly mounted to at least one side wall of the pair of side walls, the driver sprocket has a second centrally disposed through hole;
a first axle positioned in the chamber extending between the opposed walls and orthogonal thereto;
a first driven gear is mounted on the first axle for rotation thereabout and is spaced from the driver sprocket;
a second axle having a first end and an opposed second end, the first end is fixedly attached to the first driven gear and the second end is disposed in the first through hole to lock the first driven gear and the chain ring for co-rotational motion about an axis through the first axle;
a chain tensioning mechanism positioned in the chamber and secured to at least one side wall of the pair of opposed side walls;
a power input shaft has opposed ends, a first end is positioned in the second through hole and a second end extends outward from the gear box and has a flange, the power input shaft is fixedly attached to the gear box;
a chain is entrained about the driver sprocket, the first driven gear, and the chain tensioning mechanism to define a gear train; and,
wherein upon applying a force to the flange the gear box rotates about the axis and the chain is driven through the gear train and rotates the first driven gear and the chain ring about the axis.

10. The assembly of claim 9 wherein the driver sprocket has a first diameter and a first number of teeth disposed on a peripheral edge of the driver sprocket and circumferentially spaced from one another.

11. The assembly of claim 10 wherein the first driven gear has a second diameter and a second number of teeth disposed on a peripheral edge of the first driven gear and circumferentially spaced from one another, the second diameter is less than the first diameter and the second number of teeth is less than the first number of teeth.

12. The assembly of claim 10 further comprising a pedal assembly connected to the chain ring on a side opposite of the gear box for co-rotation with the chain ring about the axis.

13. A bicycle comprising:
a frame having a first end and an opposed second end, the first end has a first bracket for mounting a first wheel and the second end has a bracket for mounting a second wheel, and a bottom bracket is positioned intermediate of the first end and the second end, the bottom bracket has a sleeve with a centrally disposed axis and openings at opposed ends;
a chain ring mounted to the bottom bracket for rotation about the axis, the chain ring having a circular wall with a plurality of teeth disposed on a peripheral edge circumferentially spaced from one another, the chain ring has a first centrally disposed through hole;
a gear box having a pair of opposed walls defining a chamber therebetween;
a driver sprocket positioned in the chamber and is fixedly mounted to at least one side wall of the pair of side walls, the driver sprocket has a second centrally disposed through hole;
a first axle positioned in the chamber extending between the opposed walls and orthogonal thereto;
a first driven gear is mounted on the first axle for rotation about the axis and is spaced from the driver sprocket;
a second axle having a first end and an opposed second end, the first end is fixedly attached to the first driven gear and the second end is disposed in the first through hole to lock the first driven gear and the chain ring for co-rotational motion about the axis;
a chain tensioning mechanism positioned in the chamber and secured to at least one side wall of the pair of opposed side walls;
a power input shaft having opposed ends, a first end is positioned in the second through hole and a second end extends outward from the gear box and has a flange, the power input shaft is fixedly attached to the gear box;
a first chain is entrained about the driver sprocket, the first driven gear, and the chain tensioning mechanism to define a gear train; and,
wherein upon applying a force to the flange the gear box rotates about the axis and the first chain is driven through the gear train and rotates the first driven gear and the chain ring about the axis.

14. The bicycle of claim 13 further comprising a pedal assembly having a crank spindle, a crank arm, and a pedal, a portion of the crank spindle is disposed in the sleeve.

15. The bicycle of claim 13 further comprising a second driven gear rotatably mounted in the first bracket.

16. The bicycle of claim 15 further comprising a second chain entrained about the chain ring and the second driven gear.

17. The bicycle of claim 13 wherein the tensioning mechanism comprises:
a second axle positioned in the chamber extending between the opposed walls and orthogonal thereto;
a third driven gear spaced from the first driven gear and is mounted on the second axle for rotation thereabout;
a third axle positioned in the chamber extending between the opposed walls and orthogonal thereto; and,
a fourth driven gear spaced from the third driven gear and is mounted on the third axle for rotation thereabout.

18. The bicycle of claim 17 wherein the third driven gear further comprises a first annular flange of a greater diameter than a diameter of the third driven gear and positioned on a distal end of the second axle.

19. The bicycle of claim 18 further comprising a second annular flange mounted on a proximal end of the second axle and the third driven gear is disposed between the first annular flange and the second annular flange.

20. The bicycle of claim 13 further comprising a plurality of ball bearings for rotatably mounting the first driven gear.
